(19) United States
(12) Patent Application Publication
(10) Pub. No.: US 2011/0299672 A1
(43) Pub. Date: Dec. 8, 2011

(54) System and methods for dynamic integration of a voice application with one or more Web services

(75) Inventors: Leo Chiu, Daly City, CA (US); Arumugam Appadurai, San Ramon, CA (US)

(73) Assignee: Apptera, Inc., Sunnyvale, CA (US)

(21) Appl. No.: 12/959,175

(22) Filed: Dec. 2, 2010

Related U.S. Application Data
(63) Continuation of application No. 11/059,970, filed on Feb. 16, 2005, now abandoned.
Application No. 11/059,970 is a continuation-in-part of application No. 10/861,078, filed on Jun. 4, 2004, now Pat. No. 7,206,391.
Application No. 11/059,970 is a continuation-in-part of application No. 10/803,851, filed on Mar. 17, 2004, now Pat. No. 7,609,829.
(60) Provisional application No. 60/619,295, filed on Oct. 14, 2004.
(60) Provisional application No. 60/558,921, filed on Apr. 2, 2004.
(60) Provisional application No. 60/523,042, filed on Nov. 17, 2003.

(51) Int. Cl. H04M 11/00

(52) U.S. Cl. 379/93.02

(57) ABSTRACT

A system is provided for leveraging a Web service to provide access to information for telephone users. The system includes a first network service node for hosting the Web service, an information database accessible from the service node, a voice terminal connected to the first service node, and a service adaptor for integrating a voice application executable from the voice terminal to the Web service. In a preferred aspect, the service adaptor subscribes to data published by the Web service and creates code and functional modules based on that data and uses the created components to facilitate creation of a voice application or to update an existing voice application to provide access to and leverage of the Web service to telephone callers.

CROSS-REFERENCE TO RELATED DOCUMENTS

The present application is a Continuation of co-pending U.S. patent application Ser. No. 11/059,970, filed on Feb. 16, 2005, the disclosure of which is incorporated by reference herein. That application claims priority to provisional application Ser. No. 60/619,295, filed on Oct. 14, 2004, and is also a Continuation In Part of U.S. patent application Ser. No. 10/861,078, entitled “Method for Creating and Deploying System Changes in a Voice Application System”, filed on Jun. 4, 2004, which claims priority to provisional application 60/558,921 filed on Apr. 2, 2004. Application Ser. No. 11/059,970 is also a Continuation In Part of U.S. patent application Ser. No. 10/803,851, entitled “Multi-Platform Capable Inference Engine and Universal Grammar Language Adapter for Intelligent Voice Application Execution”, filed on Mar. 17, 2004, which claims priority to provisional application 60/523,042 filed on Nov. 17, 2003. All of the above-mentioned applications are incorporated by reference herein.

### FIELD OF THE INVENTION

The present invention is in the area of voice application software development and deployment systems and pertains particularly to methods and apparatus for dynamic creation of and implementation of data mapping between a voice application and one or more existing Web services.

### BACKGROUND OF THE INVENTION

A speech application is one of the most challenging applications to develop, deploy and maintain in a communications environment. Expertise required for developing and deploying a viable voice application includes expertise in computer telephony integration (CTI) hardware and software, voice recognition software, text-to-speech software, and speech application logic. Traditionally, voice applications are used chiefly in telephony network environments while Web-based data services are used chiefly in Internet or “online” network environments. More recently however, voice extensible markup language (VXML) voice applications have been developed that may access Web-based data sources for data provided that the correct data paths are included in the application logic.

With the relatively recent advent of VXML the expertise require to develop a speech solution has been reduced somewhat. VXML is a language that enables a software developer to focus on the application logic of the voice application without being required to configure underlying telephony components. Typically, the developed voice application is run on a VXML interpreter that resides on and executes on the associated telephony system to deliver the solution. In a digital network environment where the interacting device is an Internet enabled browser, Web services typically provide users with requested data based on the user interactions with a specific interactive Web service. However, as described above, the inventor knows of a VXML system that may access Web data.

In an online environment, a Web-accessible database containing pertinent customer data available upon request is typically accessed through a Web server, Web portal, or through a combination of a chain including a Web-server and a proxy server. Data is accessed and returned to the customer, typically operating a Web browser, based on layered interactive actions and submissions made by the customer in a request response format. The available data is hard-mapped from the access server (Web service software) to the appropriate back-end database or databases. Therefore, the requested data is returned to customer interfaces in exactly the same fashion in response to the same interaction sequences regardless of the varying needs that may be attributed to the customer accessing the data. That is to say that all customers are typically presented with identical, hard-wired data options and therefore must review the same data presentations.

With the more recent prevalence of high-speed Internet access services, there is no real economic need to use voice-based services (voice application) in a Web browsing environment in order to retrieve and present data. Data requested by a Web customer is typically displayed on the screen much faster than it could be voice-synthesized and then read to a user operating a browser-based platform. In some cases, Web-based data is made accessible to customers using a mobile telephone such as a cellular telephone adapted by browser implementation to access the Web services through which the data may be provided using a wireless protocol such as wireless markup language (WML), wireless access protocol (WAP) or other known wireless protocols. In this case, the layered nature of repeated interaction and submission to access the data dictated by the Web service is essentially the same if the same Web service version is used. Likewise, even if a special wireless-access service is used the service-to-backend data mapping is the same and even though streamlining may be practiced by elimination graphics and so on, the upload load of available data still follows a non-flexible hard-wired access sequence and can be time consuming for the customer operating the telephone to access the data.

Mapping from the access point (Web service point) to the backend data is rigidly programmed into the Web services used to access the data. Therefore, there is no dynamic way to create mapping code or to select and deliver data according to perceived customer desire unless the option desired by the customer is already hared-wired into the service. In other words, all available data presentations made through the Web services are essentially identical for all customers using the application to access the data.

The above limitations make it very challenging to successfully integrate a VXML application solution into a Web-based data retrieval service in a flexible manner. In systems known to the inventor, the voice application solutions are programmed to connect to and receive requested data using voice application templates that are pre-programmed with all of the coding necessary to access the Web data including location of, type of, and data protocol.

A voice application solution using a VXML gateway may be programmed to access data through existing Web services on behalf of requesting customers whereby those customers first dial a telephone number and interact with the application through the gateway. The coding in the voice application allows invocation of those Web services to retrieve the requested data. However, since the data mapping codes are rigid, the voice solution is limited to emulating the Web service sequence and new mapping code must also be created from the application server to the Web services. These limitations may be cumbersome and time consuming requiring every change in Web service to be hardwired into the voice application. Moreover, there would still be no intelligent flexibility options that inherent to certain intelligent voice application features known to the inventor and described with reference to applications cited in the cross-reference section of this specification. Still further, any modifications to mapping code between points in the system must then be implemented manually to the voice application requiring down time for servicing.

A system for configuring and implementing changes, including coding changes, to a voice application system is known to the inventor. The system has a first software component and host node for configuring one or more changes, a second software component and host node for receiving and implementing the configured change or changes, and a data network connecting the host nodes. In a preferred embodiment, a configured change-order resulting from activity by the first software component and host node is deployed after configuration, deployment and execution thereof requiring only one action.

In this system the voice application is typically one interacted with via telephone through a VXML gateway, the application capable of retrieving Web data. The application includes a root node or object and a plurality of subsequent dependent nodes or objects in a node hierarchy or object tree. The voice application can be running and servicing clients while it is being modified.

Orphaned nodes, or nodes that will be deleted or replaced by the new nodes, typically voice menus, sub-menus or response options, continue to function on separate branches of the application if there are pending interactions with those nodes. However, once no pending interactions are queued for those orphaned nodes, they may be purged from the application. All new interactions connecting to the interface may interact with the modified voice application nodes including the new voice modules, response options, and so on applied in the change order.

While this system enables a running voice application to be changed in mid-stream while it is running, it is most effective when the application is accessed directly using a telephony gateway and the data is known and directly accessible from a local database or network-connected database. The system will not work well in an environment where specific Web service options are used and data is only accessible through an Internet-based Web service.

The inventor knows of another system for voice application creation and deployment that includes a voice application server for creating and serving voice applications to clients over a communication network. The system includes at least one voice portal having access to the communication network, the portal node for facilitating client interaction with the voice applications. The system includes an inference engine executable from the application server. The inference engine is called during one or more predetermined points of an ongoing voice interaction to decide whether an inference of client need can be made based on analysis of existing data related to the interaction during a pre-determined point in an active call flow of the served voice application. If an inference is warranted, the system determines dynamically which inference dialog will be executed and inserted into the call flow.

In one aspect, the system further includes a universal grammar adapter adapted to produce universal grammar script from a specialized input. The universal grammar script is transformable into any one of a plurality of scripting languages supported by and referred to as a specification parameter of a speech-to-text or text-to-speech engine. While this system enables deployment of application changes in a multi-modal fashion across disparate architecture, the grammar scripting does not directly support mapping code that might be hardwired to an existing Web service for retrieval of data.

All of the above-described systems require manual programming to ensure that current data mapping from point-of-access to point of stored data is reflected in the voice application logic. Likewise any updates to those mappings have to be manually applied to the application.

Therefore, what is clearly needed is a system and a method that enables integration of a flexible VXML voice application solution to one or more existing Web-based data services in a fashion as to enable dynamic creation and implementation of modified and new point-to-point data mappings related to data requested based on customer needs as may be determined also dynamically from the point of interaction with the speech application through intelligent inference relative to the customers mood and/or interaction characteristics and behavior with the application. A system such as this would enable a more flexible and seamless integration of VXML voice applications to existing Web services and would reduce instances of human error due to missing or incorrectly applied mapping fixes in creating new or modifying existing voice applications.

### SUMMARY OF THE INVENTION

A system for leveraging a Web service to provide access to information for telephone users is provided and includes a first network service node for hosting the Web service, an information database accessible from the service node, a voice terminal connected to the first service node, and a service adaptor for integrating a voice application executable from the voice terminal to the Web service. In a preferred embodiment, the service adaptor subscribes to data published by the Web service and creates code and functional modules based on that data and uses the created components to facilitate creation of a voice application or to update an existing voice application to provide access to and leverage of the Web service to telephone callers.

In one embodiment, the first network node is a proxy server subscribed to by an enterprise hosting the Web service. Also in one embodiment, the information database is a legacy system providing data to the Web service.

In a preferred embodiment, the voice terminal is a voice-extensible markup-language compliant gateway connected to a voice-extensible markup-language compliant speech application server. In a variation to this embodiment, the speech application server is a software implement running on the voice terminal.

According to another aspect of the present invention, a service adaptor is provided for integrating a voice application to a Web service. The adaptor includes a proxy layer for connecting to a proxy server hosting the Web service, a mapping service for creating functional modules and mapping them to the Web service, and a protocol adaptor for runtime adaptation of prevalent protocols for data transfers. In a preferred aspect, the adaptor subscribes to data published by the Web service and uses the data to create components useable in the voice application to provide telephone access to leverage the Web service.

In one embodiment, the proxy layer includes a hypertext-transfer-protocol extensible-markup-language client module, a Web service client module, and a java connectivity architecture client module. In a preferred embodiment, the mapping service includes a component for creating a request object and a component for parsing a response object. The mapping service further includes a result object-set mapping service module.

In a preferred embodiment, the protocol adaptor includes a runtime adaptor for hypertext transfer protocol extensible markup language, a runtime adaptor for the Web service, and a runtime adaptor for java connectivity architecture.

According to a further aspect of the present invention, a method is provided for integrating a voice-extensible-markup-language compliant voice application to an existing Web service. The method includes steps for (a) publishing as a result of subscription, the Web service description language including any service object sets to an external service adaptor, (b) processing the received data to create java-based request and response objects, (c) mapping the resulting object sets to the Web service objects, (d) uploading the object sets to a voice application development interface, (e) validating the bindings of the object sets, and (f) installing the object sets and any related dialog into the voice application.

In a preferred aspect, in step (a), the service adaptor connects to a proxy server to receive the Web service data. In this aspect, in step (b), the objects are created for use in a voice application. Also in this aspect, in step (c), the mapping is an extension from the Web service entry ports to the voice application entry ports.

In one aspect, in step (d), the uploaded objects are java plug-in modules. Also in one aspect, in step (f), the objects are automatically launched without requiring manual coding.

### BRIEF DESCRIPTION OF THE DRAWINGS FIGURES

FIG. 1 is an architectural overview of a communication network supporting VXML gateway integration to Web services according to an embodiment of the present invention.

FIG. 2 is a block diagram illustrating basic components of the speech application server of FIG. 1.

FIG. 3 is a block diagram illustrating basic components of the Web service adaptor of FIG. 1 according to an embodiment of the present invention.

FIG. 4 is a process flow chart illustrating steps for customer interaction with a voice application according to an embodiment of the present invention.

FIG. 5 is a process flow chart illustrating steps for updating a voice application according to an embodiment of the present invention.

### DESCRIPTION OF THE PREFERRED EMBODIMENTS

The inventor provides a system and methods for integrating a telephony-based voice application system to an existing enterprise information system (EIS) leveraging existing Web services created to retrieve data for Web-based customers. The system enables dynamic data mapping from the application entry points to the Web services entry points such that in the event of new or modified services, change in data locations, type of entry ports, that mapping changes may be implemented within the voice application on the fly without requiring manual coding. The methods and apparatus of the invention are described in enabling detail below.

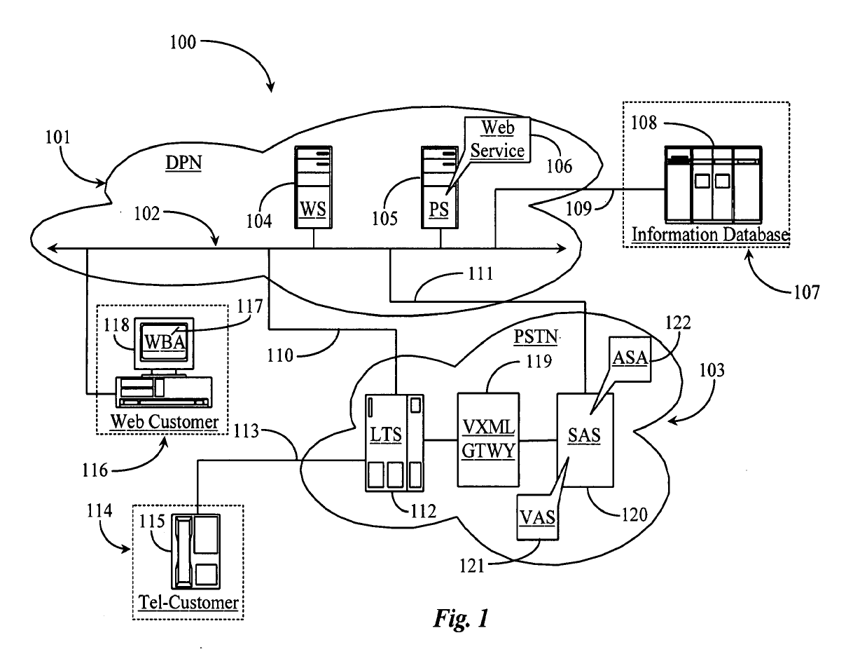

FIG. 1 is an architectural overview of a communication network 100 supporting VXML gateway integration to Web services according to an embodiment of the present invention. Communication network 100 includes a data packet network (DPN) 101 and a telephony network 103, which may be a public-switched telephone network (PSTN). DPN network 101 may be referred to hereinafter as Internet 101.

Internet 101 may instead be an Intranet, a corporate wide-area-network (WAN) or a wireless metropolitan area network (MAN) connected to any wired data network without departing from the spirit and scope of the present invention. In this embodiment, Internet 101 shall include all sub-networks such as local area networks (LANs) that may be accessible there from. Internet 101 has a network backbone 102 extending there through, which is analogous to all of the lines, connection points, and equipment that make up an Internet network as a whole. Therefore, there are no geographic limitations to the practice of the present invention.

An enterprise 107 is illustrated in this example, and is connected to backbone 102 within Internet 101 for communication. Database 108 is connected to the Internet via a network-access line 109. In preferred embodiments, access line 109 is a secure digital subscriber line (DSL) or other high-speed access line that may remain active continuously for communication purposes. Enterprise 107 may be any type of enterprise that provides information to customers of the enterprise. An example may be that of a finance-management enterprise such as a bank, where the information provided to clients upon request is customer banking and loan information. Likewise, customers may perform certain tasks such as transactions pertaining to their personal accounts.

Enterprise 107 has an information database 108 maintained therein and adapted for the purpose of storing and maintaining customer account data and other enterprise data that may be provided to authorized customers upon request, typically through request-and-response Web-based interaction. Information database 108 is analogous to an enterprise information system (EIS) such as are prevalent in the art. System 108 may be a legacy system for mass data storage and data service.

Enterprise 107 maintains a corporate Web site within a Web server (WS) 104, illustrated herein as connected to backbone 102 for communication. WS 104 typically serves customers of enterprise 107 according to enterprise goals. WS 104 typically may contain one or several universal resource locators (URLs) that when invoked activate electronic information pages in hypertext-markup-language format (HTML) so that customers may use those pages to interact with enterprise 107. Optionally, enterprise 105 may also employ the services of a Web proxy server (PS) 105 illustrated as also connected to backbone 102 for communication. PS 105 functions as an intermediary between customers and enterprise 107, or more particularly information database 108.

One or more Web-based services 106 are provided in and executable on PS 105. Web service 106 is provided and maintained by enterprise 107 as a tool to allow customers to interact therewith for the purposes of accessing their pertinent data such as data maintained in database 108 and made available by the enterprise. One with skill in the art of Web-services will recognize the general purposes of such services. That is to provide a customer interactive interface with which to accomplish various tasks related to doing business with the enterprise.

A Web customer premise 116, also referred to hereinafter as Web customer 116 is illustrated in this example and has connection to Internet backbone 102 via a network-access line 123. Access line 123 may be a DSL line, a wireless DSL connection, part of a dial-up Internet service provider architecture, or any other type of line over which content from the network may be transmitted.

Customer 116 has a personal computer (PC) 118 adapted for network communication using a Web browser application (WBA) 117. WBA 117 is a typical browser application as known in the art that may be used to navigate network 101 including resources 104, and 105. In this case, PS 105 sits between database 108 and any customer. Therefore, a customer must interact with at least one Web service 106 via WBA 117 in order to retrieve any information from database 108.

Many companies today are beginning to provide information through Web services using a Web server and service software that employs a version of Java-based connectivity architecture (JCA) and Web service description language (WSDL) to integrate their Web services to various formats and platforms that customers may use to gain access to the services. Examples known to the inventor include Tibco™, Attunity™, IBM™ and other similar companies. Formerly, these companies provided mostly proprietary database or EIS adaptors and Web-based client applications, which were configured to enable access of information. In all cases, the data mapping and formatting from information database 108 to the appropriate Web service giving access to that data is hardwired or manually coded into the software. For example, if Web customer 116 attempts to access information database using an unsupported platform or protocol then he or she will not be able to successfully interact with the system.

PSTN network 103 includes all of the equipment and lines making up the public telephone network as a whole including sub-networks. However, in some embodiments, network 103 may be a private telephony network, or in some embodiments, a wireless telephony network. In this example, a local telephony switch (LTS) 112 is illustrated and adapted as a private branch exchange (PBX), a service control point (SCP), an automated call distributor (ACD) or other types of suitable telephony switching equipment for forwarding or distributing telephony calls. LTS 112, in one embodiment, has connection to Internet 101 (backbone) 102 via a network access line 110 although this is not required in order to practice the present invention. Rather, the connectivity illustrated between switch 112 and Internet 101 simply represents common bridging capabilities between the connection-oriented-switched-telephony (COST) environment and the data-network-telephony (DNT) environment as are now in practice using suitable bridging facilities (not illustrated).

A VXML gateway 119 is illustrated within PSTN 119 and is adapted to connect customers, such as a telephony (Tel) customer 114 operating a telephone 115 to a VXML-compliant speech application server (SAS) 120. Customer 114 uses telephone 115 to connect to gateway 119 through local switch 112 using telephone line 113. VXML gateway 119 contains all of the telephony hardware and software required to interface with callers through switch 112. In addition, gateway 119 contains a speech generator and a VXML interpreter for interpreting VXML script from a voice application and rendering the dialog as synthesized speech to a caller interacting with the application. It is noted herein that SAS 120 may be a software implement running on VXML gateway 119 without departing from the spirit and scope of the present invention.

SAS 120 is directly connected to gateway 119 for communication. SAS 120 is enabled to select a voice application and execute that application upon identification related to callers such as automated number identification (ANI), destination number identification services (DNIS) and other like telephony call identification procedures. In addition, gateway 119 or switch 112 may use voice response to further help identify the purpose of a call providing SAS 120 with additional information to use to execute an appropriate voice application for interaction.

SAS 120 may have one or many more than one voice application stored therein and adapted to service callers. Likewise, those stored applications may be used to service more than one enterprise in a third-party service arrangement. SAS 120 contains, in a preferred embodiment, all of the software for creating, validating, and launching a voice application as illustrated herein by a voice application software instance 121. In this embodiment, SAS 120 is enhanced with a unique Web service adaptor (WSA) 122, which will be described in more detail below.

SAS 120 has connection to Internet 101 via a network access line 111. Network access line 111 is preferably a secure high-speed DSL line that is continually connected. However other types of network access lines may be used without departing from the spirit and scope of the present invention. In this embodiment, SAS 120 connects directly to PS 105 and voice application software communicates with Web service 106.

An enterprise hosting SAS 120 and perhaps, also gateway 119, may be one that provides voice application solutions to a plurality of enterprise customers like enterprise 107 following some business to business (B2B) service model. In this case, voice applications are created and are integrated to existing Web services of those customer enterprises whereby access to data within databases like database 108 is then extended as a service to telephone callers like customer 114. The voice applications emulate to an extent, the Web services in place and may be interacted with by telephone to request and receive data synthesized in voice, which may be heard by the caller. In some cases transactions may also be performed through the voice application leveraging the Web service to perform the transactions and confirm the results of the same.

In some prior-art systems, there is telephone service access to sets of data maintained by an enterprise that is also available to customers through one or more Web services accessed through a Web browser. However in those examples, the systems used to access the data may be completely separate systems or a single system that is rigid in formatting and not well integrated in terms of enabling the available service options for use by the disparate platforms accessing the data. For example, using a Web interface may allow access to rich text data whereas telephone access may be restricted to certain data types or categories. In some prior-art systems there may be full integration between a voice system and a Web-based system through a Web service. However, as described above, all of the coding and formatting is hardwired and the voice portion of the service is rigid in function and not intelligently flexible. Moreover, such systems must be re-coded with respect to the Web service and the integrated voice application if anything is modified or changed with respect to the legacy data system. This can cause an undue delay in services because of the downtime required to re-work the system.

In a preferred embodiment of the present invention, SAS 120 and gateway 119 form a system that can be automatically and dynamically updated in response to changes made to Web services or legacy system data without requiring any down time in affected voice applications and without requiring manual code writing or programming. WSA 122 has the required components that are adapted to identify changes described in WSDL and to create object sets, protocol bindings, and dynamic data mappings for those object sets in a fashion that renders them useful for incorporation into a voice application without requiring manual coding or programming. A voice application affected by a change on the Web service end may be quickly modified or updated on the fly to incorporate the change in service into the working voice application.

In practice of the present invention Web services like service 106 may be enabled for access by telephone by creating new voice applications that leverage those Web services to access data on behalf of telephone callers. PS 105 may contain many Web services for many different cooperating partner enterprises. Likewise there may be many more information databases like database 108 maintained by those partner enterprises.

A Web service has defined entry points, sometimes referred to also as entry ports, interaction requirements, protocol requirements, data types and data source locations. All of this information has to be available if a Web service is successfully deployed and functions correctly. In a preferred embodiment WSA 122, also termed a backend proxy adaptor, interacts with PS 105 and the particular Web service in order to receive WSDL objects published by the Web service to aid in creating a new voice application to leverage the service. WSA 122, among other tasks, creates dynamic data mappings from the points of the Web services entry ports back to the voice application terminal and entry ports. More detail about interaction between the adaptor and Web service software will be detailed later in this specification.

Voice menu options and response dialogs may then be created that enable a telephone caller like customer 114, using telephone 115 to select which data available through the Web service and voice application will be accessed and returned. A hypertext-transfer-protocol (HTTP) XML client, a Java-Connectivity-Architecture (JCA) client as well as a Web services client in the adapter allow the voice application side access to all of the mapping code, data description, entry port descriptions, including service description required to create the interactive menus that will be used to leverage the Web service. A dynamic mapping capability and protocol binding adaptation capability is provided within WSA 122 to provide the mapping from the appropriate Web service entry ports back to the voice application terminal and ensures the protocols or bindings, which are reusable, are appropriate for the type of data accessed and for the platform hosting the data as well as for the platform accessing the data.

Using SAS 120, intelligent menu navigation options may be created that allow a telephone user to economically navigate a voice application to order offered data and to control the process in ways that Web customers may not be able to. For example, if a transaction history for a banking customer is accessed from WBA 117, it may contain 100 or more transaction lines that display on PC 118 as a scrollable list of data entries. Telephone customer 114 may have access to the same data, however voice commands may be provided to enable the customer to navigate in a friendlier manner, considering that the data is synthesized into voice and spoken back to the customer. Commands like “next 5 transactions”, “skip 20”, “last 5”, “end”, “repeat”, “return to menu”, and the like may be incorporated into the voice application functionality.

In some cases, a rigid hierarchal structure of a Web service may be somewhat reduced for telephone users. For example, a Web customer may be required to have all of the available data categories displayed on a personalized Web page accessible via login procedure before he or she may begin to select options and drill down to desired data. Depending on the speed of the Internet connection and the level of security, this may take some time. On the voice application side, a user familiar with the available voice commands may simply speak the category of the data he or she is interested in, for example, “recent transactions” without having to listen to all of the menu options or categories. In other words, exact Web service HTTP navigation requirements do not have to be observed with a voice application enabled with shortcut commands and intelligent interaction navigation.

Once a Web service is integrated with a voice application, updates and modifications to the Web service or underlying data options are easily transferable to the voice application without requiring, in many instances, downtime or manual programming. For example, simple movement of data from one location to another location can be handled automatically by the dynamic mapping service without requiring any manual modifications to the voice application. A data category no longer offered can also be automatically handled through automated de-activation of the specific menu option leading to the now non-existent data.

One with skill in the art of voice services and integration of those to existing Web services will appreciate that through “intelligent adaptation” voice applications may be provided quickly and may be maintained more economically than those that are manually programmed to rigidly emulate a Web service, or those that are programmed directly to a legacy database, for example.

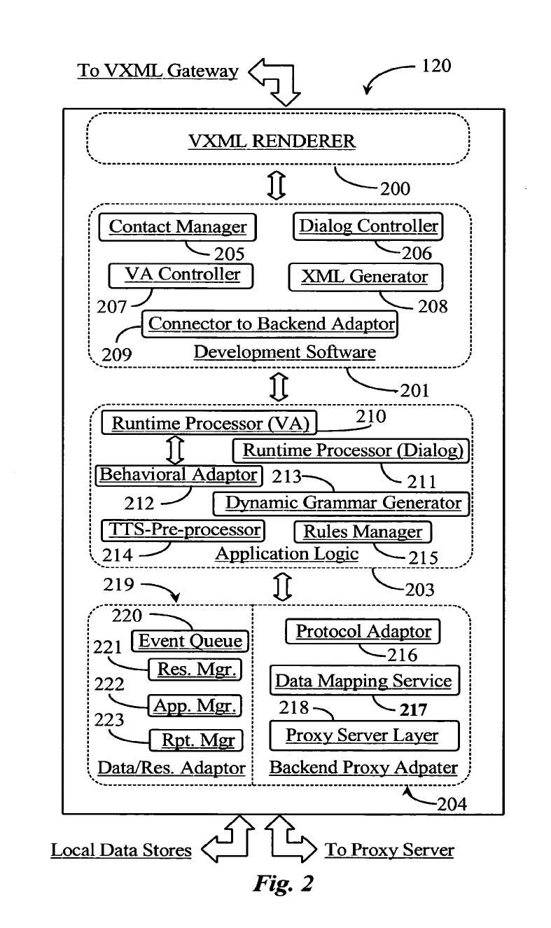

FIG. 2 is a block diagram illustrating basic components of speech application server 120 of FIG. 1. SAS 120 contains many components that are known to the inventor and are described with reference to U.S. patent applications and co pending applications listed in the cross-reference section of this specification. Therefore, components already described will be reintroduced for the purpose of providing background information, but will not be greatly detailed unless those components are modified to enable practice of the present invention.

Server 120 has a VXML rendering component provided there in and adapted to render VXML to a VXML-compliant gateway such as VXML gateway 119. In this way, the voice markup language (data results) can be interpreted and synthesized by gateway 119 interacting with telephone callers. SAS 120 has a voice application development (VAD) interface 201 provided thereto and adapted to enable new voice application creation and existing voice application modification. Basic components within development software 201 include a contact manager 205, a dialog controller 206, a voice application (VA) controller 207, and an XML generator.

A connector 209 to a backend database adaptor (WSA 122) is provided, in a preferred embodiment, to enable development software 201 access to Web service data, including created object sets and bindings created by the adaptor.

SAS 120 has application logic 203 provided thereto and adapted to support execution and run of one or more configured voice applications. Application logic 203 contains basic components including a voice application (VA) runtime processor 210, and a dialog runtime processor 211. These processors control application behavior and internal location and execution of dialog according to voice responses from telephone callers. Additional components include a text to speech (TTS) pre-processor 214, and a rules manager 215. TTS pre-processor interprets user voice response according to enterprise and application rules. A dynamic grammar generator 213 is provided and adapted to generate voice application grammar intelligently based on user interaction results.

Application logic 203 has a behavioral adaptor 212 that works closely with processor 210. Adaptor 212 interprets certain behaviors of callers interacting with a voice application and detects certain caller states like, mood derived from voice tone, interaction anomalies, or historical or statistical repetitions in option selection. Adaptor 212 may intervene at certain points in a voice application flow termed inference points and the voice application menu and dialog options can be dynamically changed according to interpretation of caller state or inferred need as detected by adaptor 212.

In one embodiment, SAS 120 may contain voice applications that are integrated with third-party Web services and voice applications that are programmed to access resources directly without using Web services. In either case, local data resource adaptor 219 is provided and is modified to cooperate with a backend proxy adaptor 204 analogous to WSA 122 described with reference to FIG. 1. Adaptor 219 has an event queue to hold current requests made through interaction with one or more running voice applications.

A resource manager 221 is provided within adaptor 219 and is a management utility for local resources including access to proxy adaptor 204. An application manager 222 provides a utility for confirming which requests belong to which running application. A report manager 223 provided activity reports consistent with activity results and workflow so that voice applications may be fine-tuned and the like.

In a preferred embodiment, proxy adaptor 204 is active whenever there are voice applications running that are integrated with Web services hosted by one or more known proxy servers adapted for the practice of the present invention. For example, voice applications that are programmed directly to access data stored locally or on the Internet without leveraging Web services may operate without using adaptor 204. However, to practice the present invention, applications configured to Web services rely on adaptor 204 to provide support both in the creation of those applications and in the maintenance thereof as well as an appropriate client through which access to those services is enabled.

Adaptor 204 includes a proxy server layer 218, which is adapted to interface with a proxy server analogous to PS 105 described with reference to FIG. 1 above. Layer 218 is enabled with all of the required software clients to interact with any Web service software defined as a Web service integrated with a voice application. Layer 218 is configured to receive, in interaction, WSDL including the hard code mapping data from the service to an information system analogous to system 108 of FIG. 1.

Adaptor 204 has a data mapping service 217 provided thereto and adapted to extend the mapping code between the information system and the Web service to include subsequent mapping to a voice application terminal or SAS 120 and further to voice application entry points. In this way, entry ports of a voice application, which are defined as the points in the application that function to return one or more data types upon request, or to perform some transaction are automatically mapped to the appropriate ports of the Web service. Additionally, adaptor 204 includes a protocol adaptor 216, which is adapted to provide the correct protocol requirements along with the extended mapping. In practice, this information is generated in the form of a set of enhanced Java objects that contain the information. These objects are adapted to be used by the development software 201, as plug-in building blocks for creating new and for modifying existing voice application functionality.

Adaptor 204 enables voice applications to be created and maintained more efficiently by leveraging the existing WSDL defining the Web service or services that the application leverages to obtain and return data for telephone callers. At the same time, enterprises providing existing Web-based data services can simply incorporate telephone users into the same services through integration rather than by paying for or creating completely separate voice services that may require data duplication or additional hardware and software for accessing the data. By integrating Web services to a voice solution through a proxy server and an adaptor like adaptor 204 much work may be reduced or eliminated altogether for both provider and enterprise clients.

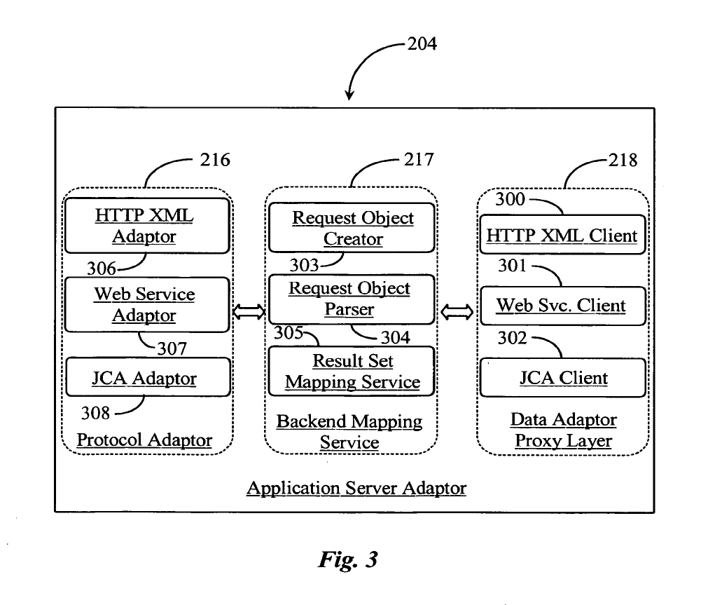

FIG. 3 is a block diagram illustrating basic components of backend proxy adaptor 204 of FIG. 2 according to an embodiment of the present invention. Proxy adaptor 204 is analogous to WSA 122 described with reference to FIG. 1. Adaptor 204 includes proxy layer 218. Proxy layer 218 as described above functions as an interaction interface with Web service software analogous to software 106 described with reference to FIG. 1.

Proxy layer 218 includes a JCA client 302 that functions as an extension to Web service JCA architecture used to enable access to a legacy database or information system analogous to system 108. A Web services client 301 is provided and adapted as an extension to Web services through which WSDL may be transferred and interpreted. Proxy layer 218 also has a HTTP XML client 300 that is adapted as an extension to HTTP XML protocol used by Web services. Proxy layer 218 serves to retrieve all of the relevant data required to define function of a voice application that will integrate with a Web service. This data may be accessed using a publish/subscribe model.

Information received as objects through proxy layer 218 is processed by backend mapping service 217. Service 217 includes a request object creator 303. Request object creator 303 is responsible for defining or creating abstract objects that are equivalent, in the Web service, to request objects defining the functionality enabling Web customers to “request” data from the service.

A response object parser 304 is provided within mapping service 217 and is adapted to parse response objects used by the Web service to deliver the data to the Web customers. In one embodiment, these objects may be created from raw WSDL defining the Web service. In another embodiment, the Web service may publish these objects, an entire set of which, define the request/response interaction functionality provided by the Web service to standard Web customers. The data used in creating these objects represents data that is defined by entry points of a Web service and includes WSDL, data type, data attributes, port identification, operation types, workflow, and so on. Once request and response objects are defined within adaptor 204, a mapping service 305 is responsible for extending the mapping code of those objects to create a resulting set of Java objects that are subsequently mapped from the Web service entry points to a voice application development software. Once a resulting set of Java objects are created and mapped into the voice application software, they may be used as plug-in modules in the voice application that correspond to the Web service objects.

Proxy adaptor 204 includes protocol adaptor 216. Adaptor 216, as described above, provides appropriate protocol binding information and associates that information to objects created and mapped by the mapping service. Adaptor 216 includes an HTTP XML adaptor 306, a Web services adaptor 307, and a JCA adaptor 308. The resulting object set output by adaptor 204 is, in a preferred embodiment, a complete set of Java objects that may be imported into voice application development software analogous to development software 201 of FIG. 2. The resulting set of objects may also include instructional data such as identification of any pre-existing replacement objects, which may already incorporated into a voice application.

In a preferred embodiment, a user operating development software may select and use created Java objects as functional modules for creating the voice application functionality. The objects contain the entire entry port identification and description, protocol bindings, data type description, operations descriptions, and access requirements for access and return of data through the Web service. The data mapping created here is an extension of the mapping provided between the Web service and the data source. It is noted herein that the objects are typically classed as related object sets including at least one request object defining the operation of requesting a particular data type and a correlating response object defined as the system response action of providing the requested data type according to the prevailing protocol.

In one embodiment, a Web service already integrated with a voice application is expanded to incorporate new operations and, possibly new data types. In this case new menu option and dialog creation may be required to accommodate a new set of objects. Also in one embodiment, a user operating voice application development software through a developer interface may easily remove and change object bindings and may attach the modules to appropriate access points in a voice application call flow.

In one embodiment, a new voice application may be created and integrated with a new Web service already created by running adaptor 204, connecting to the Web service software and retrieving the published Web service information including the WDSL, HTTP, and JCA information. All of the final created objects in a set defining the Web service interaction flow are functional and useable modules. Appropriate dialogs and menu options may be created using VAD software for invoking and using those modules to interact with the Web service. Likewise, dialog options may be constructed to further regulate how requested data is presented within the telephony environment. This may be accomplished by creating commands that a user may speak while interacting with the system. The spoken commands may invoke certain operations that regulate or control the nature of the voice response at the gateway.

It is important to note herein that the telephony gateway side of the voice application operates using certain telephony protocols. Therefore object bindings include those that support the telephony platform used to access the voice application.

In maintenance of an existing voice application/Web-service package, adaptor 204 may be used as a conduit and as an updating tool. For example, if a data mapping has changed (Web service side) for a particular data type available through the service, then the adaptor will receive this change when it is completed and published and may be enabled to access the particular Java object already in use used in the voice application that defines the affected Web service object. Once located, the object can be modified with the new data mapping between the Web service and new data location. The object may also, in one embodiment, undergo a protocol binding validation check to make sure no new protocol binding is required to support the new data location. The object may be automatically modified, in this case, while the application is running as long as the bindings are specified and are available. The option menu and call flow may remain the same in this case as long as the data type returned is the same type of data returned as the result of a request.

In one embodiment, adaptor 204 may, during an update, create a brand new Java object set having all of the same attributes as an existing object set already used in the voice application accept for a different mapping code. In this case, the new object set is output to a queue provided in the voice application development software and may then be manually or, in some cases, automatically installed into the running application as a change order object set. Back up system dialogs can be incorporated for users whom are navigating the old dialog tree such as “The data you requested is momentarily unavailable”. “Please return to main menu and try the option again”. In this way, all of the customers interacting with the application may still receive the requested data without hanging up once the new object is in place in the call flow.

If new data or service options are created at the Web-service end, then those objects may be published and received by the adaptor. The adaptor may then create and map the new Java objects and may forward those objects the voice application development (VAD) software and new voice dialogs and menu options may be created to support the new Web service option while the application is still running As soon as the new dialogs and menu option are created, they can be installed into the running application.

In some cases, a Web service may be modified to an extent that an entirely new voice application may be required to continue to support it. In this case, many of the original objects created from the old Web service description language might be reused. That is to say that bindings and mappings may be striped from an object to reveal the abstraction for an entry port description, wherein new mapping and bindings may be applied to form a new version of the object.

It is noted herein that objects used in a Web service for Web customers map to correlating objects used in the voice application for telephone access to the data. For example, a dialog object “recent transactions” in a voice application will correspond to clicking an icon labeled transactions on a Web page. The voice system response will correspond to the return of requested data for display in the Web browser. The difference in the voice system object is that the data returned by the response object is voice synthesized and the presentation may be further controlled through use of spoken voice commands.

One with skill in the art of voice system/Web service integration will appreciate that some hierarchal interaction sequences of a Web service may be reduced or eliminated in the voice application through intelligent speech to text interpretation of speech and behavioral adaptation routines without departing from the spirit and scope of the present invention.

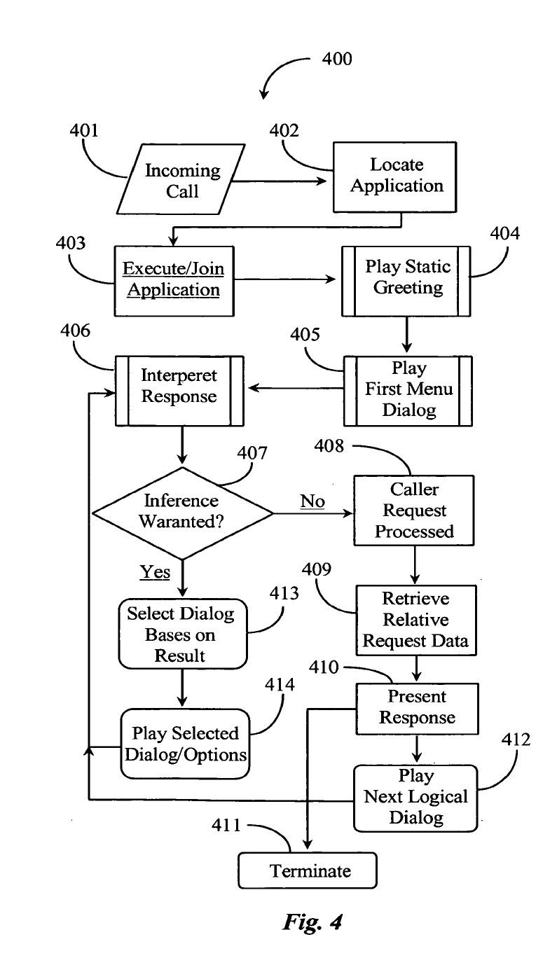

FIG. 4 is a process flow chart illustrating steps for customer interaction with a voice application integrated to a Web service according to an embodiment of the present invention. At step 401 the VXML gateway detects an incoming voice call. At step 402, the VXML gateway locates the appropriate voice application in the voice application server. The identification of the proper voice application can be based on number identification techniques as well as through separate interaction with a caller.

Once the voice application is located in step 402, it may be executed in step 403, or the caller may be connected to a running application. At step 404, the voice application plays a static greeting. At step 405, the voice application plays a first menu dialog. The menu dialog will contain voice selectable options that the caller may invoke by speaking the option name.

At step 406, an inference point may evaluate the caller's navigation behavior related to the option menu interaction. At step 407, the inference engine may decide if an inference is warranted. For example, if a caller has repeatedly requested a particular option related to menu 405 with regard to interaction history data, then an inference may be warranted at step 407. Another example might be that the caller has trouble navigating the menu option. An inference may be warranted in this case as well. An inference point may be inserted anywhere in a call flow and may be tied to navigation behavior, detected mood of the caller, or caller history. It is important to note herein that inference results can lead to changes in call flow. Call flow data entry ports (objects) are mapped to Web service entry ports (objects) and inference on the telephony side will also determine which data available through a Web service will be accessed and returned. In a preferred embodiment, the Web service functional ports are independently executable such that no existing Web hierarchy must be observed such as first viewing current balance information and then viewing transactions.

If no inference is warranted at step 407, then at step 408 the caller's request is processed according to the functional operation called. It is assumed at this point that the correlating Web service is active and being leveraged by the voice application. If a caller for example spoke the phrase review transaction history, then the command from the voice application activates the Web service equivalent operation and the Web service accesses that transaction history. Protocol binding on the telephony side determines how the data will be formatted. For example, HTML pages containing the list of transactions cannot be used because the interface is a voice interface. Therefore, the appropriate mechanism may be to send the data in VXML format to the VXML gateway where it may be synthesized into voice for the caller. In a running voice application, data transformation staging and presentation can be entirely independent from the Web service format.

Steps 409 and 410 involve retrieving the data and then presenting the data response according to the rules in place on the telephony side of the system. After listening to the response or a desired portion thereof as enabled through voice command, the caller may optionally terminate the connection to the voice application at step 411. In one embodiment, the caller may navigate to another portion of the voice application after listening to the response in step 410 triggering the application to play the next logical menu dialog at step 412. The process may proceed to another inference point at step 406.

If an inference is warranted at step 407, then at step 413, the voice application selects an available menu or other dialog, the selection thereof based on the result of the inference. For example, if the inference determines the caller is having trouble or is frustrated, then a help menu may be played. At step 414, the system plays the selected dialog or menu options and the call flow may again proceed to another inference point. If no inference is warranted then the call flow may proceed according to the caller's request at step 408.

It is important to note herein that a Web service has rather rigid interaction options that are visibly presented to a customer in an interactive interface. On the voice application side, the functional options of the Web service are mapped to functional options in the voice application and additional enhancements on the voice application side may be provided for any order of access to the functional service options. Moreover, data presentation through the voice application by TTS pre-processing can be regulated using additional voice commands that may be spoken and recognized by the system at any point in the data presentation process.

There are many possible variations regarding exactly how the voice application will read data accessed through the Web service to the caller. If the data is voluminous like a 30-day transaction activity history of a checking account, it may be broken down into transaction type, for example, check or automated transaction machine (ATM) by voice command spoken by the caller. Moreover, data range periods may be ordered by the caller through voice commands that specify the period such as “first week” or “second week”. Commands may also be combined like “second week ATM transactions”. Web service data returned to the telephony side that is not required is simply deleted. Therefore granularity of data returned can be increased from what the Web service allows Web customers without requiring any modification of the Web service.

One with skill in the art will recognize that the steps included in this flow are exemplary only and are intended as just one example of a possible interaction sequence of a voice application integrated with a Web service. The versatile nature of a voice application tree as known to the inventor may include both statically offered and dynamically selected presentations. Further, the exact nature of a Web service through which data is accessed by using the voice application will partly determine the construction and complexity of the voice application, but in no way dictates the operational face of the application. Any Web service functionality may be entirely transparent to a caller.

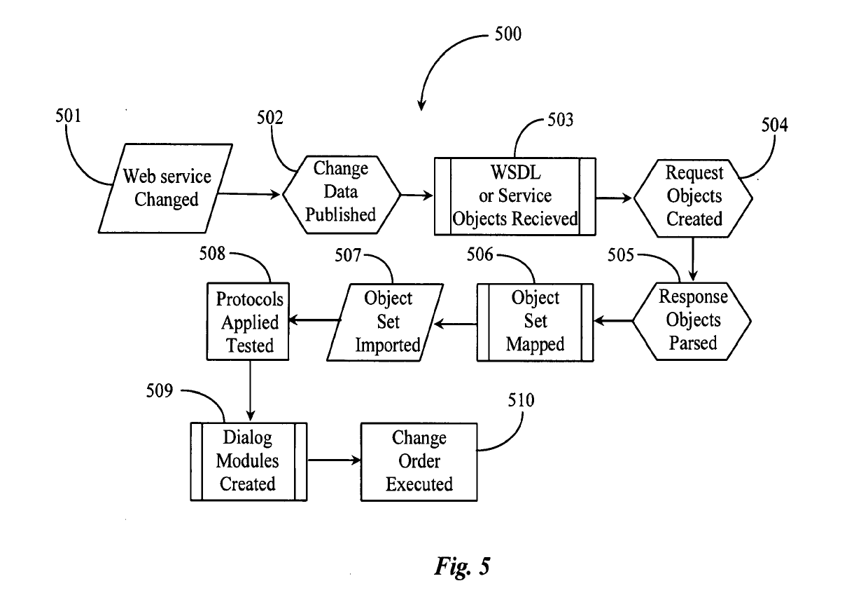

FIG. 5 is a process flow chart illustrating steps for updating a voice application integrated with a Web service according to an embodiment of the present invention. At step 501, a change is performed regarding a Web service integrated with a voice application. In this case, a change in the service might be any number of modifications to the service ranging from what types of data may be returned by the service to how that data may be accessed normally by Web customers. It is important that any changes in functionality or data type and location be incorporated into the voice application, which leverages the service.

At step 502, the Web service publishes the change data. In this step, objects created for the Web service may be published. Likewise, WSDL data that may be used to create an object might be published instead of service objects. WSDL is an XML formatted description language that may be used to describe the modifications to the Web service. In the case of objects published, which would be a typical implementation, then at step 503 the objects are received by the adaptor, more particularly through the proxy layer adaptor and forwarded to the mapping service of the adaptor.

For more clarification, consider that request and response objects are created by the Web service and are published at step 502 and received at step 503. These objects compliment each other logically, for example, a request object defines a request action and the response object is the system action taken to return the requested data. However, these published objects only contain the required information to facilitate Web users accessing the service through a Web browser. The adaptor must create correlating objects that may be manipulated on the telephony side of the integrated system. Therefore, a request object creator (part of mapping service 217) creates a Java object for invoking the service request object. This happens in step 504. AT step 505, the response objects received are parsed for data type and mapping location to the information source or host system.

The mapping service then correlates the object sets and extends mapping information at step 506 back to the VXML gateway where the responses will be played. Therefore, for one set of service objects furnished by a Web service, there is a set of Java objects created for the voice application that map to the original objects at the Web service. There may be many object sets defined in the Web service so there must be a like number furnished in the voice application if full service access is desired.

The created object sets are Java objects, which once mapped, will, upon execution in the voice application, will invoke the Web service objects to enable the request response interaction from the voice application interface analogous to VXML gateway 119. Before the integrated system can be used, the resulting object set is mapped between the voice application and the Web service at step 506 and then sent to the voice application development software for integration into the product at step 507. Steps 507 and 506 may in fact be a single step. All of the finished object sets may now be plugged into voice application slots without requiring hard coding.

At step 508, reusable protocol bindings may be applied to the object sets if required. If a new protocol is enabled, then a new binding may be created. One object set may also have more than one binding. At step 508, a new object with bindings may also be tested and validated before being installed into the voice application.

At step 509, dialog modules, menu option changes, or the like may be created if the service change warrants. In many cases, where minor changes occur but the data requested and returned is the same, no additional voice application dialog need be created. However, if a portion of the dialog, such as the menu options must be changed to reflect new functionality, then a backup menu dialog may be temporarily switched on in a running voice application until the created dialog or new options are created and ready for installation. At step 510 a change order may be executed to automatically update the voice application with the service changes while it is currently running An application manager may monitor the running state of the application and make the installation at a point when no users are navigating the portion of the application to be changed.

In change order installation according to one embodiment temporary backup dialogs may also be called on to keep users occupied momentarily until the new functionality is installed and working For example, where an old option, say ATM or Checking is expanded by adding Transfers, a temporary dialog may inform a caller by playing something like “momentarily you will have access to balance transfer information”, “If this is desired return to the previous menu”. After one or more loops, a caller may then be presented with the expanded dialog and then will be able to say “Transfers” to gain access to a list of recent transfers made by the caller. Of course, in some embodiments where changes are wide spread throughout the Web service, a voice application may have to be reconfigured and then redeployed.

One with skill in the art will recognize that the number and order of steps in this example may change without departing from the spirit and scope of the present invention. The exact order and number of steps will depend on the nature and complexity of changes to the Web service.

The method and apparatus of the present invention can be applied to any existing Web service used on a data network to enable browser-based access to data stored in virtually any connected information database. The present invention used with a proxy server provides a functional hub for partner enterprises to launch their Web services and to have them integrated for telephone access. A small client module may be provided to existing Web services to enable the adaptor of the present invention to subscribe to published Web service data for use in creating voice application solutions and for modifying existing solutions to conform to Web service modifications and changes in data type and/or location.

XML Mapping

The voice application development software can receive and interpret XML code from Web services, however a special format is used to enable the node navigation feature in mapping. An XML package may contain any number of different nodes. However, the node located at the end level-1 is the only node that is allowed to repeat more than one instance.

To further illustrate the above-mentioned scheme, consider that the XML received for an update has n number of nodes. The node located at the n-1 level is the only one allowed to repeat more than one time. This is because a counter variable is set on the n-1 node name. All the other node values are obtained always by giving the index of 0 to the node name. The counter variable on the n-1 node is exposed to the voice application developer while creating the voice application. As part of the navigation capability through the nodes, the counter variable is automatically incremented by the speech application server for every iteration of each XML node.

Consider the following simple example of XML:
1 <Firm><HumanResources><Employee><Name> . . . </Name><Address1> . . . </Address1><Address2> . . . <-/Address2><City> . . . </City><State> . . . </State><Zip> . . . </Zip><PhoneNumber> . . . </PhoneNumber></Employee><Employee><Name> . . . </Name><Address1> . . . </Address-1><Address2> . . . </Address2><City> . . . </City><State> . . . </State&g-t; <Zip> . . . </Zip><PhoneNumber> . . . - . . . </PhoneNumber></Employee><Employee> . . . </Employee> . . . </HumanResources></Firm>

In current voice application development, a developer would only see the following 7 variables in the code.

Firm.HumanResources.Employee.Name

Firm.HumanResources.Employee.Address1

Firm.HumanResources.Employee.Address2

Firm.HumanResources.Employee.City

Firm.HumanResources.Employee. State

Firm.HumanResources.Employee.Zip

Firm.HumanResources.Employee.PhoneNumber

The voice application studio enhances the XML by generating 3 variables that are added to the XML code. These are MaxCounter; CurrentCounter; and EndOfList.

The MaxCounter variable is used to find out how many Employee nodes are present in the XML where as the Current counter variable is used to find out at which level among the employee nodes the current cursor is set. Also, the EndOfList variable is provided as an “ease of use” variable to provide the Boolean output of the comparison (Current Counter=Max Counter).

Once the XML is parsed, and when any particular node value needs to be obtained, the VAD server fetches the node value using the following syntax:

Firm.HumanResources[0]. Employee[<CURRENTCOUNTER>]. Name[0] to get the value of the node “Name”.

One with skill in the art of XML will recognize that by providing the array or counter variables, the studio (VAD) will support any version or extension of XML. The counter variables are generated and provided for every level of nodes except the root node. The application developer need only to keep track of the correct counter variables at correct nodes on demand. Using this XML enhancement, any kind of XML imported from Web services is supported by the VAD platform.

The method and apparatus of the present invention may incorporate all or a portion of the described elements and modules in various aspects of the invention without departing from the spirit and scope. The spirit and scope of the present invention shall only be limited by the following claims.

What is claimed is:

1. A system for leveraging a Web service to provide access to information for telephone users comprising:
a first network service node for hosting the Web service;
an information database accessible from the service node;
a voice terminal connected to the first service node; and
a service adaptor for integrating a voice application executable from the voice terminal to the Web service; characterized in that the service adaptor subscribes to data published by the Web service and creates code and functional modules based on that data and uses the created components to facilitate creation of a voice application or to update an existing voice application to provide access to and leverage of the Web service to telephone callers.
